(19) United States
(12) Patent Application Publication
(10) Pub. No.: US 2012/0150565 A1
(43) Pub. Date: Jun. 14, 2012

(54) Patient Controlled and Initiated Method and System for Physician Reporting of Patient Status

(75) Inventors: Chad R. Gordon, Lutherville, MD (US); Scott Anzel, Philadelphia, PA (US); Adam Barker, Charlotte, NC (US); Michael James Vaites, Newtown Square, PA (US)

(73) Assignee: MDConnectME Inc., Philadelphia, PA (US)

(21) Appl. No.: 13/323,262

(22) Filed: Dec. 12, 2011

Related U.S. Application Data
(60) Provisional application No. 61/421,719, filed on Dec. 10, 2010.

(51) Int. Cl. G06Q 50/24

(52) U.S. Cl. 705/3

(57) ABSTRACT

A system and method for communicating status of individual patients to selected populations of residents include a computing platform, a database in communication with the computing platform, first, second, and third electronic communication devices used by patients, physicians and recipients respectively, and a software algorithm residing on the computing platform, controlled by the patient using the first communication device for implementing communications and patient status to the recipients.

### CROSS-REFERENCE TO RELATED PATENT APPLICATION

This application claims the benefit, under the applicable provisions of 35 USC 119 and 120, of the 10 Dec. 2010 filing date of provisional U.S. patent application Ser. No. 61/421,719 submitted in the name of Scott Anzel and Dr. Chad Gordon.

### BACKGROUND OF THE INVENTION

1. Field of the Invention

This invention relates to communications in the world of healthcare and embraces communication among patients and healthcare professionals, using a patient-controlled network including the patient's emergency contacts, family, friends and social networking sites.

2. Description of the Prior Art

Since the beginning of the practice of medicine, physicians have been ethically obligated to maintain physician-patient communications in confidence and to maintain in confidence medical information regarding the physician's patient, specifically the patient's medical condition. In recent years with passage of the Health Insurance Portability and Accountability Act, referred to commonly as “HIPAA”, what were previously ethical obligations of confidentiality on the physician morphed into legal obligations, the breach of which could expose physicians to severe monetary and administrative sanctions, putting physicians' licenses to practice medicine and physicians' economic well-being at risk.

With the continued spiraling increase in health care costs, government at all levels has been wrestling with approaches to reducing the rate of increase of these costs. Uniformly governmental authorities and those in the private sector advocate increased use of electronic technology, with electronic transmission and storage of patient medical information being seen as a part of the solution to the spiraling health care cost problem.

Electronic transmission and storage of patient health care information raises privacy and security concerns. These concerns have led in part to enactment of the Health Information Technology for Economic and Clinical Health Act, commonly referred to as “HITECH”, which is part of the American Recovery and Reinvestment Act of 2009. This Act extended the privacy and security provisions of HIPAA to business associates, namely nurses and office personnel of covered entities, namely physicians and hospitals. The Act also created civil and criminal penalties applicable to such business associates, as well as to physicians and hospitals. Accordingly, after passage of HITECH, physicians face the risk of loss of their license to practice medicine and face severe economic sanctions and criminal penalties if they or any of their associates, namely employees such as nurses, bookkeepers and the like, breach confidentiality respecting a patient's medical information.

### SUMMARY OF THE INVENTION

This invention provides a system and method by which a patient preparing for a hospital stay or medical procedure may define a collection of messages to be sent with the patient's approval by the physician during the patient's medical procedure, for example, while the patient is under the effects of anesthesia. The system allows the patient the option of composing the messages by him or herself, or to compose the messages in conjunction with his or her healthcare provider, or to rely entirely on his or her health care provider for the message construct. The system also provides a set of pre-prepared, “canned” messages from which the patient and the patient's health care provider can select if the patient so desires. Once the patient, normally with the assistance of the patients' health care provider, has composed/approved/selected/delegated selection the messages of interest to the patient, those messages are stored and flagged for use by that patient's healthcare provider as authorized by the patient.

The patient supplies contact information for recipients of messages concerning the patient's status to be sent by the physician through the patient's own computer to recipients as selected by the patient. Those recipients may be categorized hierarchically, ranging from the patient's spouse or significant other, through the patient's children, through the remainder of the patient's family, to the patient's employer and to the patient's social friends and acquaintances. Each message can be coded to be sent to only one of these groups, or to several of the groups, or to all of these groups. Each message, as authorized by the patient and sent by the patient's physician, passes through the patient's computer, where the messages are held if the patient has not enabled the computer to automatically forward those messages to the selected recipients, according to a forwarding protocol established by the patient as to the hierarchy of groups and selection of groups to whom the messages are to be sent.

The system further provides for the patient to send messages to prospective recipients of patient status messages, whereupon those recipients may choose to join the invention MDconnectME network and share in the benefits of that, or just to receive messages as authorized by the patient, or those recipients may decline completely to receive such messages.

Further provided within the inventive, often referred to herein as MDconnectME, network for the patient and others that have joined in that network is messaging capability permitting the patient to send messages to others enrolled in the MDconnectME network without the patient's healthcare provider being involved in the sending or receipt of those messages, or even viewing those messages.

All of the messages within the MDconnectME system are preferably encrypted so that there is confidentiality of every message sent, and neither the patient nor the physician need be concerned that unauthorized third persons may see or receive any of the messages, whether sent only by the patient or by the physician with the patient's approval, thereby providing a secure, HIPAA and HITECH compliant network messaging system for patient status, patient condition and other information.

In one of its aspects, this invention provides a system for communicating medical status of individual patients to selected populations of recipients, where the system includes a computing platform, a database in communication with the computing platform, where the database includes a list of physicians and various healthcare providers authorized by MDconnectME and the health care organization to use the computing platform to communicate patient status to selected populations of recipients. The database further includes a list of patients of the physicians and a set of hierarchical list of recipients for each of the listed patients, with the hierarchy of lists being defined as to recipient importance, with each list including contact information for each of the recipients on the list. The system further includes a set of patient status messages with status updates and messages for each of the patients within the health care organization. The system yet further includes a software algorithm permitting a given, authorized physician to select one or more of the hierarchical recipient lists for a selected one of that physician's patients, and to select a patient status message indicative of the patient's condition from the set of messages for the selected patient, facilitating transmission of the selected message, at the patient's option and only with the patient's advanced authorization, to the recipients on the selected hierarchical list.

The system may further include a set of patient reminder messages that are accessible by each physician with the algorithm permitting a given one of the physicians to select a message from the set of patient reminder messages and to transmit the selected patient reminder message to the physician's patient.

The patient reminder messages are preferably preprogrammed and are preferably categorized specific to the physician's and/or surgeon's specialty or discipline for ease of quick retrieval.

The system may yet further include a set of commercial advertising messages for transmission to recipients set forth in the hierarchical lists and the algorithm may optionally further select one or more commercial advertising messages for transmission to the recipients set forth in the hierarchical lists as a part of a message selected by a physician, for retransmission at the patient's option to the recipients of the selected hierarchical list.

The invention yet further embraces a method for communicating medical status of patients to selected populations of recipients by a method comprising a series of steps, some of which may be desirably performed prior to each patient undergoing hospital treatment and commencing with compiling a collection of messages expected to reflect that patient's status at various times for various patient outcomes. The method further optionally proceeds by presenting each collection of messages to the patient for whom the messages were collected, for approval or modification by the patient prior to that patient undergoing hospital treatment. In other cases the messages are not submitted to the patient for advance approval prior to that patient undergoing hospital treatment. In either case, the method then proceeds with storing the collections of messages for the individual patients as approved or modified by the individual patients. In this aspect of the invention, the method further proceeds with receiving from each patient one or more lists of recipients for selected ones of the messages reflecting a patient's status preferably at selected future times. These lists of recipients will be targeted for each message to reflect a patient's status at selected future times. The method then orders the list of recipients for each patient in a hierarchy as to their emotional and economic importance to the particular patient. The method yet further proceeds with, for each patient undergoing hospital treatment, periodically selecting a message from the collection of messages for that patient, reflective of the patient's current status. Next, the method proceeds by selecting one or more of that patient's hierarchical ordered lists of recipients for distribution of the selected message thereto and concludes with transmitting a selected message to a computing platform controlled by the particular patient for optional transmission by the patient-controlled computing platform to the recipients in the selected hierarchical groups.

In another of its aspects, this invention provides a HIPAA and HITECH-compliant, secure communication network, within which a healthcare professional may communicate directly with a patient with regard to an upcoming medical procedure or provide educational information to the patient. The healthcare professional may also communicate via the patient with the patient's network of emergency contacts, family, friends, and social networks, as preselected and authorized by the patient. These communications may be auto-forwarded, as preauthorized by the patient, so as to provide those entities with periodic status updates with regard to the patient.

The system and methods of the invention provide secure, HIPAA and HITECH complaint, cloud-based facile mobile solutions to assist health care systems and facilities and healthcare professionals to be more efficient by cutting redundancies and unproductive tasks with patients, while increasing secure message communication between healthcare providers, patients, and patient loved ones. This results in increased patient satisfaction, leading to higher reimbursements for the healthcare professional from Medicare and Medicaid, from which many, if not all healthcare institutions receive major portions of their revenue. The system and method of the invention facilitate more efficient communication for healthcare professionals with their patients and increases communication abilities for patients and their families as respecting the patient's status. Such efficient communication results in better patient care, giving a participating healthcare professional competitive positioning, resulting in more referrals. Additionally, the system and method of the invention create more communication between healthcare professionals, patients and the patient's family, yielding increased brand awareness for the healthcare facility and providing the healthcare facility a competitive edge in today's fiercely competitive healthcare environment.

The invention in its method and system aspects provides cloud-based service permitting status updates and messages to be sent from an Internet-enabled device of any type, to a device used by the recipient, no matter what the recipient's preference as to the particular device.

The invention further permits advertisements of patient gifts, employing automated one-click links displayed at the bottom of each message with pre-loaded geographic data for ease of delivery, medical healthcare resources, travel and accommodations and the like, all in the context of a healthcare provider-patient communication. Importantly, by facilitating on-line gift selection (aided by patient-directed selections termed a “registry”), Internet purchasing, and accelerated gift delivery, the system and method of the invention directly enhances each patient's “healing environment” in a positive way during one's in-hospital or in-facility stay. This, in turn, aids one's psycho-social well-being and recovery, by decreasing psychological morbidity in hospitalized patients and those who otherwise feel isolated from their loved ones. Use of the system and method of the invention will eventually shorten hospital admissions in all patients, especially those of pediatric age, who will no longer feel disconnected from their family and friends irrespective of geographic boundaries.

The invention operates in an environment including patients, healthcare professionals in a patient-controlled and defined network consisting of the patient's emergency contacts, family, friends and the patient's social networking sites, if any.

### BRIEF DESCRIPTION OF THE DRAWINGS

FIGS. 1 through 6 and FIG. 8 are interrelated flow charts detailing the system and method of the preferred embodiment of the invention and illustrating use of the same.

FIG. 7 is a collection representative screen shots, illustrating what would appear on a terminal, personal computer, or other electronic device in the course of using the system and method of the invention.

FIG. 9 is a schematic representation of the cloud based aspect of the system and method of the invention when implemented in its preferred embodiment.

FIG. 10 is a pictorial representation of the manner of use of the method of the invention.

### DESCRIPTION OF THE PREFERRED EMBODIMENTS AND BEST MODE FOR PRACTICE OF THE INVENTION

The system and method of the invention provide cloud-based services permitting status updates and messages to be sent from an Internet-enabled device of any type and to be accessible on a device, preferably Internet-enabled, as selected by the patient or a recipient, no matter what the patient's or recipient's preference as to the device. In the course of practice of the invention, a physician sending status updates may be using a Blackberry or iPhone or Android or similar Internet-enabled device, while the patient or patient's family members may receive the updates on a cell phone, a personal computer or an iPad, for example. Communication methods between the parties may include e-mail, SMS (short message service), text, recorded video or audio formats, photographs or web-enabled messaging.

In the course of practice of the invention, using a secure communication network a healthcare professional may communicate directly with the healthcare professional's patient with regard to an upcoming medical procedure or provide educational information. The healthcare professional may also communicate with the patient's network of emergency contacts, family and friends, and the patient's preferred social networks, as preselected by the patient. The physician may utilize auto-forwarding, if preauthorized by the patient, so as to provide the patient's network of emergency contacts, family, friends and preferred social networks, with periodic status updates with regard to the condition of the patient. Examples of such status updates are “Patient is now anesthetized, comfortable and is being prepped for surgery”; “Patient is now in surgery”; “Surgery completed successfully and the patient is being moved to the Intensive Care Unit”.

The patient may also use the system and method of the invention to communicate with the patient's emergency contacts, family and friends, as well as the patient's preferred social networks.

The system allows surgeons, doctors, resident physicians, nurses, receptionists, secretaries, physical therapists, social workers, case managers, and the like to deliver status updates respecting their patients through whom the patient's emergency contacts, family, friends and social networks learn of patient's condition in a HIPPA-compliant and HITECH-compliant manner. Many benefits are seen with the wide variety of users. For instance, by allowing social workers and case managers to use the invention MDconnectME, each patient's social support system is connected to the progress of their stay leading up to the time of hospital discharge. This translates into a more streamlined process for hospital discharge and/or transfers, in turn resulting in decreased length of hospital stays and saving health systems millions of dollars each year.

Furthermore, since each patient, at time of discharge, is sent home to family and friends who had been connected with MDconnectME invention, the family and friends are more aware of the prescribed regimens set forth by the patient's physician. This, in turn, provides an atmosphere more conducive to “medical compliance”, which in-turn equates to “decreased hospital re-admissions”. “Hospital re-admissions” is a key measure of hospital rankings and more, dictates Medicare's “pay-for-performance” pay scale at the end of each fiscal year. Thus, MDconnectME assists health system/hospitals in receiving revenue each year just due to decreased re-admission rates resulting from improved physician-patient communication via MDconnectME.

Another great value of MDconnectME is the usage by resident physicians in training since the greatest hurdle in medical education in the 21st century is work-hour restriction. Since most of the “floor-work” learning performed by junior level trainees involves communicating with emergency contacts and family in a variety of specialty settings, MDconnectME improves medical education by increasing efficiency, saving the government millions of dollars each year in doctor training costs, and at the same time preventing hospitals from being fined millions of dollars each year for violating ACGME-sanctioned “work-hour restrictions”.

In the course of practice of the invention, a hospital facility or a physician practice can e-mail a link or provide a sign-up card with a QR code, namely a matrix-like two-dimensional bar code, readable by a scanner, a mobile phone with a camera, or various smartphones. This may be sent from the hospital or from a physician's office in which the patient is scheduled for a procedure, with the message inviting the patient to enroll in the system. Once the patient enrolls in the system embodying the invention, using the encrypted log-in information, the patient is able to direct and control the flow of information regarding the patient's status. The patient is further able to give and to receive instant communications and specify health-related information and educational materials the patient may want to receive through the system.

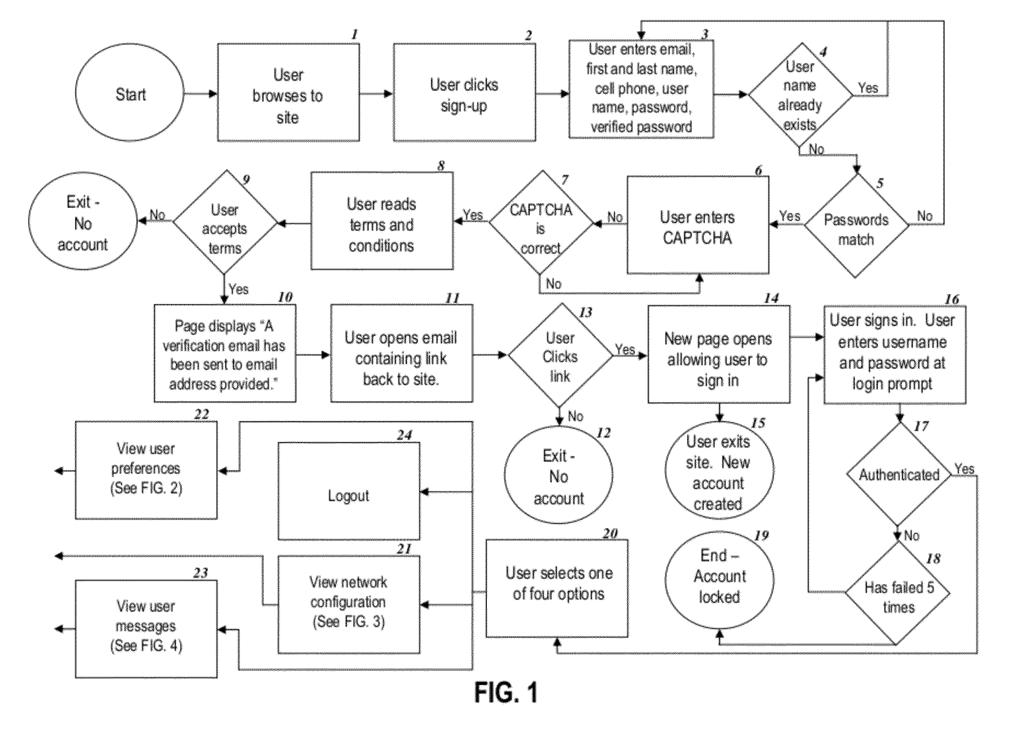

Referring to the drawings and particularly to FIG. 1 depicting the flow of events in the course of use of the system of the invention, use of the system by a user commences with the user browsing as shown in box 1 on the user's Internet browser to the site for MDconnectME. As shown in box 2 the user, after finding the MDconnectME.com site, signs up by clicking on the sign-up button to establish a user account. As shown in box 3 the user then enters the user's email information, the user's first and last name, the user's cell phone number, a selected user name, a selected password and verifies the newly selected password.

As shown in box 4 the software system of the invention then checks to see whether this user already exists in the system. If this user already exists in the system, the user is prompted by an indicator that user information for that user is already in the system. If the user does not already exist in the system, the system software checks, as shown in box 5, to see whether the password the user has selected matches the verified password the user put in. If the password and the verified password match, the system proceeds. If the password and the verified password do not match, the user is given another opportunity to enter a password and a verified password, and the system checks again to see whether the re-entered password and the re-entered verified password match.

Having found a match of the password and the verified password, as shown in box 6, the system proceeds to have the user enter a CAPTCHA routine, requiring the user to type letters or digits from a distorted image appearing on the screen. If the user's CAPTCHA input is correct, the system proceeds as shown in box 7; if it is incorrect the user is given another opportunity to enter the correct information for the CAPTCHA screening. Upon the user entering the correct CAPTCHA information, the system proceeds, as shown in box 8, with the user reading the terms and conditions that the user is required to accept in order for the user to be accepted and to have an account for that user created within the system. As shown in box 9 the user is given the option to accept the terms and conditions or to reject the terms and conditions. If the user rejects the terms and conditions, the system exits and the user is not permitted to further participate.

If the user accepts the terms and conditions, as shown in box 10, a page is displayed on the user's computer stating that “A verification email has been sent to the email address provided” thereby indicating that the user account has been opened and established on the system.

The system proceeds as shown in box 11 with the user opening an email containing a link back to the system website.

If the user fails to click on the link, the user is denied further use of the system and no account is established for the user, as indicted in box 12. If the user clicks on the link as indicated in box 13, a new page opens on the user's screen as indicated in box 14, allowing the user to sign in to the system. The user may at that time choose not to sign in and may exit the site, having created the user's new account as indicated in box 15. If the user signs in, the user may proceed to use the system.

Still referring generally to FIG. 1, the procedure by which a user, having established an account, makes use of the system is set forth graphically with the user beginning by signing in with the user's user name and password at the log in prompt appearing on the user's home computer or other Internet-enabled device, as indicated by box 16. The system checks the user's user name and password as being authentic as indicated by box 17. If the user name and password are found to be bogus, the user is permitted to re-enter a user name and password at the log in screen. If the user fails to enter the proper user name and password five consecutive times, the user is not permitted to further use the system and the user's account is locked by the system as indicated in boxes 18 and 19, for a preselected time sufficient to prevent brute-force password cracking.

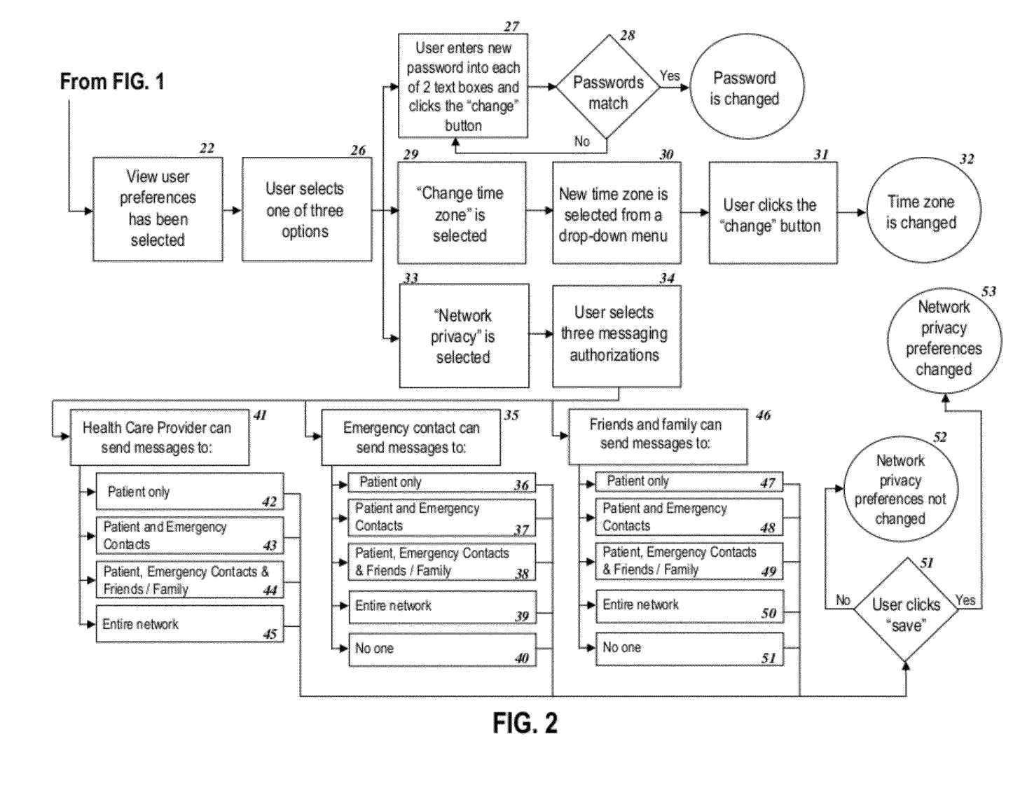

If the user has entered an authentic user name and password, the user is presented with a screen permitting the user optionally to view his/her user messages, to view the network, to view his/her preferences, or to log out as indicated in box 20. If the user chooses to log out, the user may not further actively use the system during this session, as indicated by box 24. If the user elects to view the network as indicated in box 21, the user is taken to a screen where the user may view the current network of emergency contacts, the network of the user's friends and family and the network of available social media as indicated by box 22 in FIGS. 1 and 2. From this screen the user may elect to see the user's network configuration of the hierarchy of emergency contacts, friends and family, and social media, all as set forth in the hierarchical data base set up for that particular user.

If the user had elected to view the user's preferences as indicated in box 22, the user is then taken to a screen where the user's current preferences are presented and the user is permitted to change the time zone, the user's email address to which the messages will be sent for relay to emergency contacts, friends and family, etc. and will be permitted to change his password if desired.

If the user had elected to view messages as indicated in box 23, a screen appears showing the user's messages as established by the user to be sent to the recipients selected by the user as a message is triggered by a doctor.

Referring to FIG. 2, if view user preferences has been selected, as indicated in box 22 the user then has three options to select, as indicated in box 26. Using one option to change the user's password, the user enters the selected new password into each of two text boxes appearing on the screen and clicks the “change” button as indicated in box 27. If the passwords match, the password is changed; if the passwords do not match the user is given another opportunity to enter the new password into each of the two text boxes as indicated in box 28.

A second user-selected option involves changing the time zone, as indicated in box 29. A new time zone is selected from the dropdown menu as indicated in box 30. The user then clicks a “change” button appearing on the screen and the time zone is changed, all as indicated in boxes 31 and 32.

If the third option, namely “network privacy”, is selected, the user selects messaging authorizations as indicated in boxes 33 and 34. The user may authorize one of his emergency contacts to send messages, with such messages being sent to the patient only, or to the patient and to the health care provider, or to the patient, the health care provider and others of the patient's emergency contacts, or to the patient, the health care provider, the patient's emergency contacts and the patient's friends and family, or to the entire network, or to no one, as indicated by boxes 35 through 40 in FIG. 2. Alternatively, the user may select messaging authorizations for the health care provider permitting the health care provider to send messages to the patient only, to the patient and to the patient's emergency contacts, or to the patient, to the patient's emergency contacts and to the patient's friends and family, or to the entire network, all as indicated by boxes 44 through 45 in FIG. 2. As a third messaging authorization, the user may choose to authorize friends and family to be able to send messages to the patient only, or to the patient and the patient's emergency contacts, or to the patient, the patient's emergency contacts and the patient's friends and family, or to the entire network, or to no one all, as indicated in boxes 46 through 51 on FIG. 2.

Once the messaging authorization activity has concluded, the user clicks “save” and a box appears for the user to select whether or not to actually save the network privacy preferences that have been changed, indicated by boxes 51 through 53 in FIG. 2.

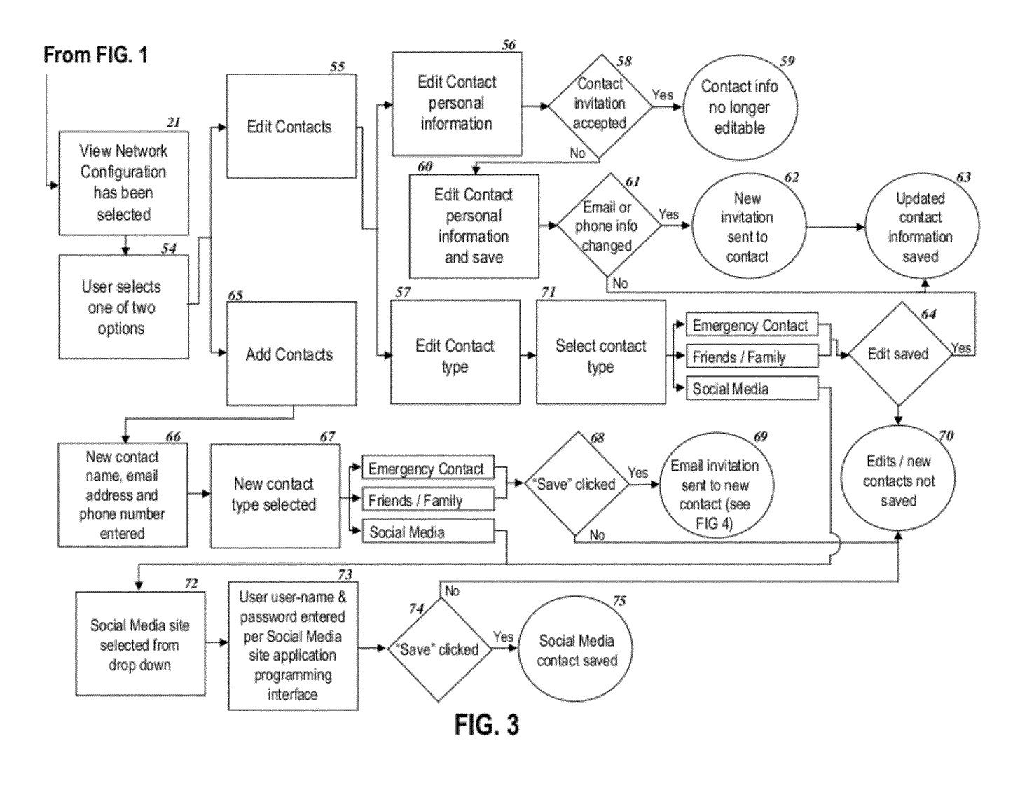

Referring further to the drawings and particularly to FIG. 3, if the view network configuration has been selected, as indicated by box 21 appearing both in FIG. 1 and in FIG. 3, the user selects one of two options, as indicated by box 54 in FIG. 3. The user may elect to edit contacts, as indicated by box 55 in FIG. 3, in which case the user has the option to edit his contact personal information or to edit the contact type as indicated by boxes 56 and 57 respectively in FIG. 3. In the course of editing contact information, the system inquires as to whether the contact invitation has been accepted, as indicated by box 58 and if the answer is yes, the contact information is no longer editable, as indicated by box 59 in FIG. 3. If the contact invitation has not been accepted, the user may proceed to edit the contact personal information and to save it, as indicated by box 60 in FIG. 3. The system then asks whether the email or phone information for the contact has changed, as indicated by box 61 in FIG. 3, and if the answer is “yes”, the user may have a new invitation sent to the contact as indicated by box 62 and the updated contact information will be saved, as indicated by box 63. If the email or phone information has not changed, updated contact information is still saved, as indicated by box 63, and the edits are saved, as indicated by box 64 in FIG. 3.

If the user selects the option of adding contacts as indicated by box 65 in FIG. 3, the user may enter a new contact name, email address and phone number for the new contact as indicated by box 66 in FIG. 3. The user then indicates to the system the type of the new contact, as indicated by box 67 and whether that new contact is an emergency contact, one of the friends and family contacts, or relates to the social media, as indicated by box 67 and the choices immediately adjacent thereto. If the new contact is either an emergency contact or one of the friends and family contacts, the user clicks “save”, as indicated by box 68, and either an email invitation is sent to the new contact, as indicated by box 69, or the edited new contact information is not saved.

If the user opts to edit the contact type, a screen appears permitting the user to select the contact type, as indicated by box 71, with edits for emergency contacts or friends and family contacts having the choice of being saved, as indicated by box 64, or not saved as indicated by box 70. If the selected contact type is social media as indicated to the right of box 71, the user selects a social media site from a dropdown menu as indicated by box 72 and enters the user's user name and password according to the social media application programming interface as indicated by box 73, whereupon the user has the choice to save or not save that social media contact, as indicated by box 74, with box 75 indicating that the social media contact has been saved.

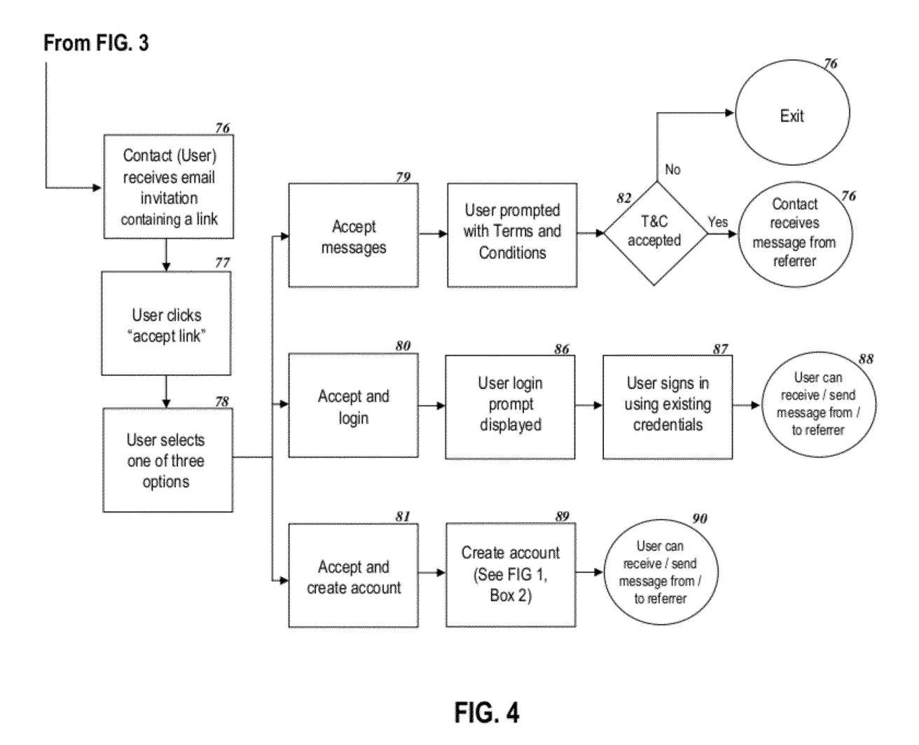

Referring to FIG. 4, when a contact of the user receives an email invitation to join the MDconnectME network, that invitation includes a link, as indicated by box 76 in FIG. 4. If the user clicks on “accept link”, as indicated by box 77 in FIG. 4, the user has three options among which to select, as indicated by box 78 in FIG. 4. The three options are for the user to accept messages, as indicated by box 79, for the user to accept the invitation and to log in as indicated by box 80, or for the user to accept the invitation and to create an account as indicated by box 81, all in FIG. 4. If the contact elects the option of accepting messages as indicated by box 79, this “user” is then prompted with terms and conditions, as indicated by box 81 in FIG. 4. If the “user” accepts the terms and conditions, as indicated by having the choice in box 82, the contact will thereafter receive messages from the referrer, as indicated by box 83 in FIG. 4. If the user does not accept the terms and conditions, the user exits from the system, as indicated by box 85 in FIG. 4.

If the user elects the accept and log-in option as indicated by box 80 in FIG. 4, a log-in screen prompt is displayed as indicated by box 86 whereupon the user may sign in using existing credentials as indicated by box 87, whereupon a user can send or receive messages to or from the referrer, as indicated by box 88 in FIG. 4.

If the user elects the option to accept the invitation and to create an account, as indicated by box 81 in FIG. 4, the user creates an account following the protocol set forth in FIG. 1 and described above respecting box 2 in FIG. 1, all as indicated by box 89 in FIG. 4. Upon creating the account, the user can receive and send messages in the MDconnectME system to and from the referrer, as indicated by box 90 in FIG. 4.

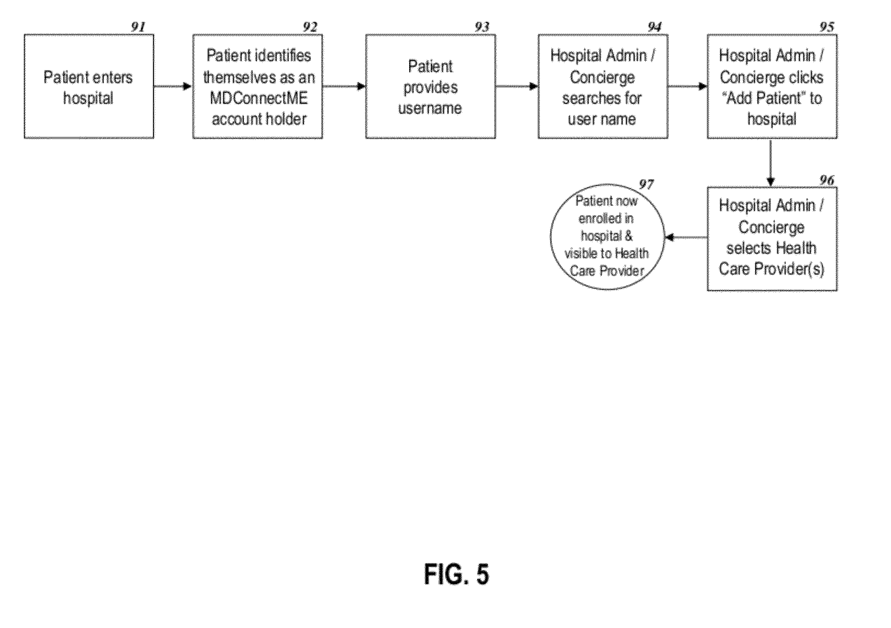

Referring to FIG. 5 showing the sequence of events when a patient, having enrolled in MDconnectME enters the hospital, the patient enters the hospital as indicated in box 91. The patient then identifies him or herself as an MDconnectME account holder as indicated in box 92 and the patient then provides the patient's user name to the hospital administrator or concierge as indicated in box 93. The hospital administrator or concierge searches the MDconnectME database for the user name and, upon finding that the user name is bona fide and identifies the patient and exists in the MDconnectME system, the hospital administrator or concierge clicks on “Add Patient” to open the patient's records as respecting the MDconnectME system for use by the patient and the healthcare providers in the hospital. The hospital administrator or concierge then selects “Healthcare Providers” as needed for the patient, as indicated in box 96. Once this is complete, the patient is now enrolled in the hospital and visible to the selected healthcare providers over the MDconnectME system, where the selected healthcare providers can view the patient's information and may communicate with the patient using the MDconnectME system.

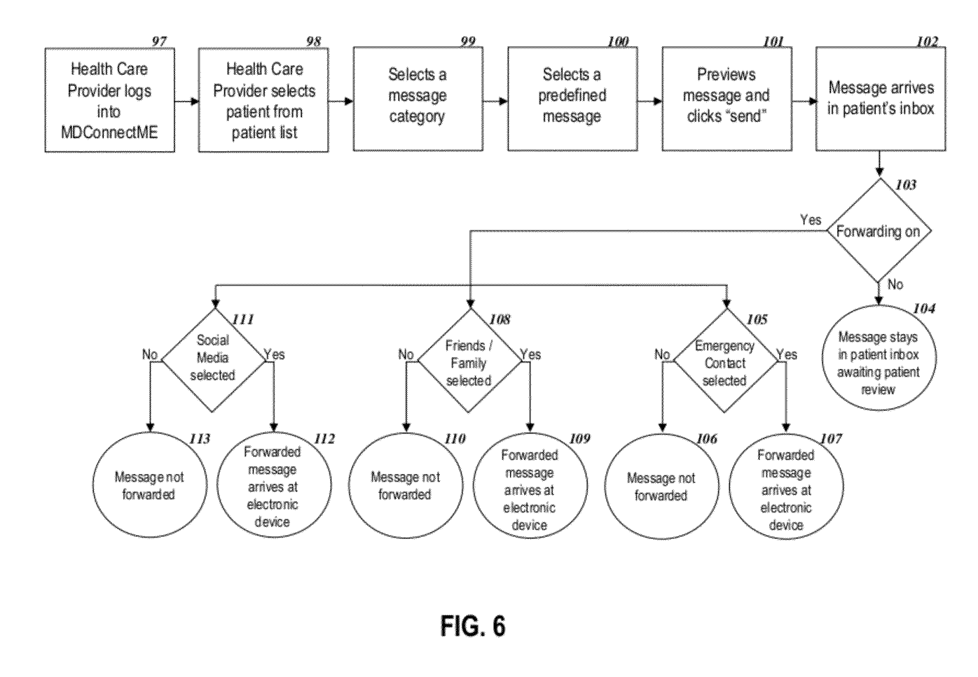

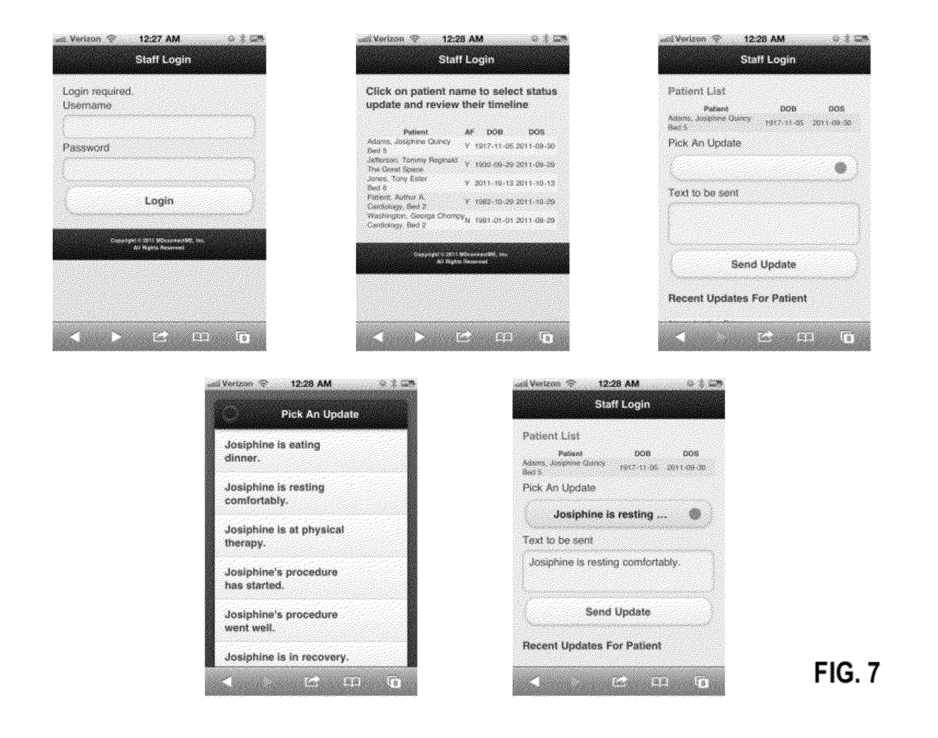

Referring to FIG. 6 showing the sequence of events when a healthcare provider uses MDconnectME, initially, as indicated by box 97, the healthcare provider logs onto MDconnectME. The healthcare provider log-in screen is illustrated in FIG. 7 and appears to the upper left thereof as “Staff Log-in”. The healthcare provider selects a patient from the patient list as indicated by Box 98. An exemplary screen as seen and used by the healthcare provider to select the patient from the patient list appears in the middle of the upper row of screen shots illustrated in FIG. 7. The healthcare provider then proceeds to select a message category as indicated by Box 99, and from the available messages in that message category selects a pre-defined message as indicated by Box 100. The healthcare provider then previews the message and, if it is acceptable to the healthcare provider, the healthcare provider clicks “Send” whereupon the message is forwarded to the patient's Inbox as indicated by Boxes 101 and 102 in FIG. 6.

If the patient has set up the patient's computer or other Internet-enabled device to forward MDconnectME system messages, the message will be forwarded as indicated in Box 103. If the patient has not set up the patient's computer or other Internet-enabled device for forwarding of messages generated by the healthcare provider, the message stays in the patient's Inbox awaiting the patient's review as indicated by Boxes 103 and 104 in FIG. 6.

If the patient has enabled the patient's computer or other Internet device to forward MDconnectME message received in the patient's Inbox, the algorithm will have been set by the patient to forward the selected message either to the patient's emergency contacts only, as indicated by Box 105, or to the patient's friends and family only, as indicated by Box 108 in FIG. 6, or to the patient's selected social media, as indicated by Box 111, or perhaps to two of these, or perhaps to all three, namely the patient's emergency contact grouping, the patient's friends and family grouping, and the patient's selected social media as indicated by Boxes 105, 108 and 111 collectively.

If the patient elects to have the message forwarded only to the patient's emergency contact(s), the message is forwarded and arrive at the emergency contacts' electronic devices indicated by Box 107 in FIG. 6. If the patient's emergency contacts have not been selected by the patient to have the forwarded message received, the message is not forwarded to the emergency contact(s) as indicated by Box 105 and 106 in FIG. 6.

Similarly, if the patient selects friends and family to receive the forwarded message, the forwarded message would be received by the friends and family at their electronic devices as indicated by Boxes 108 and 109 in FIG. 6. On the other hand, if the patient had not selected the patient's friends and family for receipt of the message, the message would not be forwarded to the friends and family as indicated by Boxes 108 and 110 in FIG. 6.

In a similar manner, if the patient had elected to have the forwarded message sent to the patient's selected social media, the message would be forwarded to the electronic devices and interfaces of the particular social media for that particular patient, as indicated by Boxes 111 and 112 in FIG. 6. If the patient had not elected to have his or her social media receive the forwarded message, the message would not be forwarded as indicated by Boxes 111 and 113 in FIG. 6.

When the healthcare provider logs on to MDconnectME and selects a pre-defined message, the healthcare provider may click on “Pick an Update” appearing in the screen to the upper right-hand corner of FIG. 7. Upon clicking on that area of the screen, the screen appearing in the lower left-hand corner of FIG. 7 appears where some, but not nearly all, of the pre-defined messages available to the healthcare provider are shown in exemplary form. The healthcare provider clicks on the selected one of those messages, whereupon the previous screen, as illustrated at the upper right-hand corner of FIG. 7, appears again, but with the selected message in abbreviated form appearing under the heading “Pick an Update” and the text of the full message appearing in the box immediately below that. The healthcare provider then clicks on “Send Update” to send that message to the patient's computer, from where the patient's computer, if forwarding has been enabled, forwards the message on to the selected recipients, according to the forwarding protocols established by the patient. Of course, if forwarding is not enabled on a patient's computer or other Internet-enabled device, the message will stay in the patient's Inbox, awaiting the patient's review, as indicated by boxes 103 and 104 in FIG. 6.

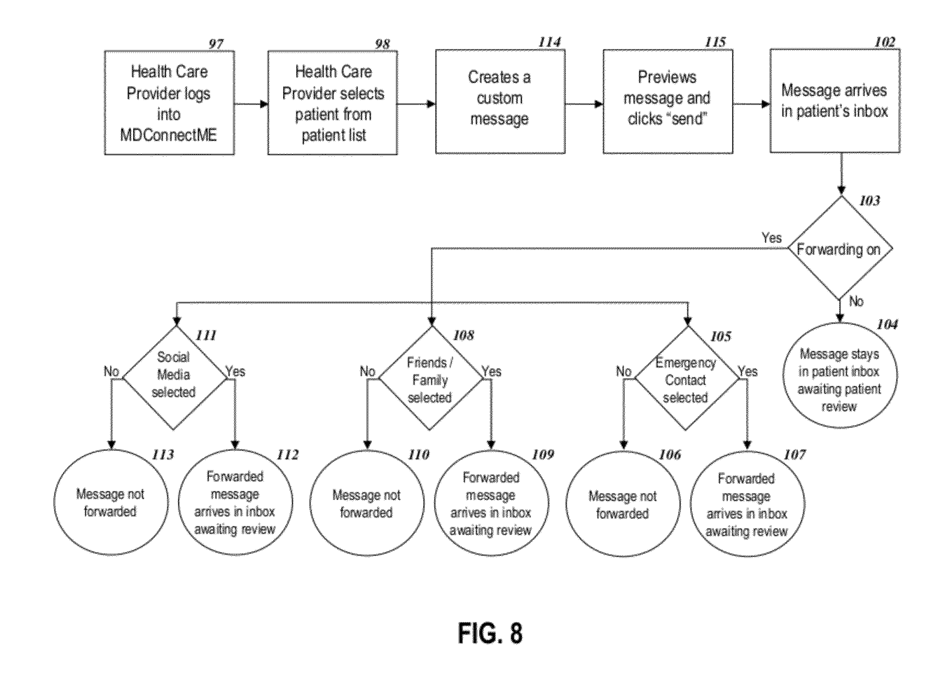

FIG. 8 illustrates operation of the MDconnectME system and method when a healthcare provider desires to send a message regarding the patient's status and desires that message to be a custom message, not one of the pre-programmed messages available in the MDconnectME system. As indicated by box 97 in FIG. 8, the healthcare provider logs on to the MDconnectME system and the provider selects a patient from the patient list as indicated by Box 98. The healthcare provider then sees a screen as depicted to the upper right hand corner of FIG. 7, allowing the healthcare provider to create a custom message by typing in the text to be sent as the message in the box below the wording “Text to be Sent”, in the screen shot appearing at the upper right hand corner of FIG. 7. The healthcare provider types the message, previews the message, and if the healthcare provider is satisfied with the message clicks “Send”, as indicated by Box 115. At this point, the procedure followed by the MDconnectME system is the same as that described with respect to pre-defined messages as set forth with respect to FIG. 6, namely the message, this time a custom message, arrives in the patient's Inbox as indicated in Box 102 in FIG. 8. If the patient has authorized forwarding and has left the computer or other Internet-enabled machine in a “forwarding on” configuration, the message is forwarded. If the patient has not left the machine in a “forwarding on” configuration, the message is held in the patient's Inbox awaiting the patient's review as indicated by boxes 104 and 103 in FIG. 8.

If the patient has authorized retransmission of the message by leaving “forwarding on” in the patient's computer or other Internet-enabled device, the message is forwarded according to the flags associated with that message. Specifically, the message may be forwarded only to the patient's emergency contact if that is the forwarding protocol selected, in which case the forwarded message arrives in the emergency contact(s) Inbox awaiting review by the emergency contacts as indicated by Boxes 105 and 107 in FIG. 8. If the forwarding protocol did not call for forwarding the message to the emergency contacts for the patient, the message is not forwarded as indicated by Boxes 105 and 106 in FIG. 8. If the patient's forwarding protocol called for the message to be forwarded to the patient's friends and family, the message would be forwarded to an Inbox of the friends and family, awaiting their review as indicated by Boxes 108 and 109 in FIG. 8. If the forwarding protocol had indicated that the message was not to go to friends and family, the message would not be forwarded to the patient's friends and family, as indicated by Boxes 108 and 110 in FIG. 8.

If the patient had elected to have the message forwarded to the patient's social media selection(s), the message would be forwarded to the appropriate social media site(s) for review by them as indicated in Boxes 111 and 112 in FIG. 8. If the social media were not included in the forwarding protocol, the message would not be viewed by any subscribers to social media, since it would not be forwarded to them as indicated by Boxes 111 and 113 in FIG. 8.

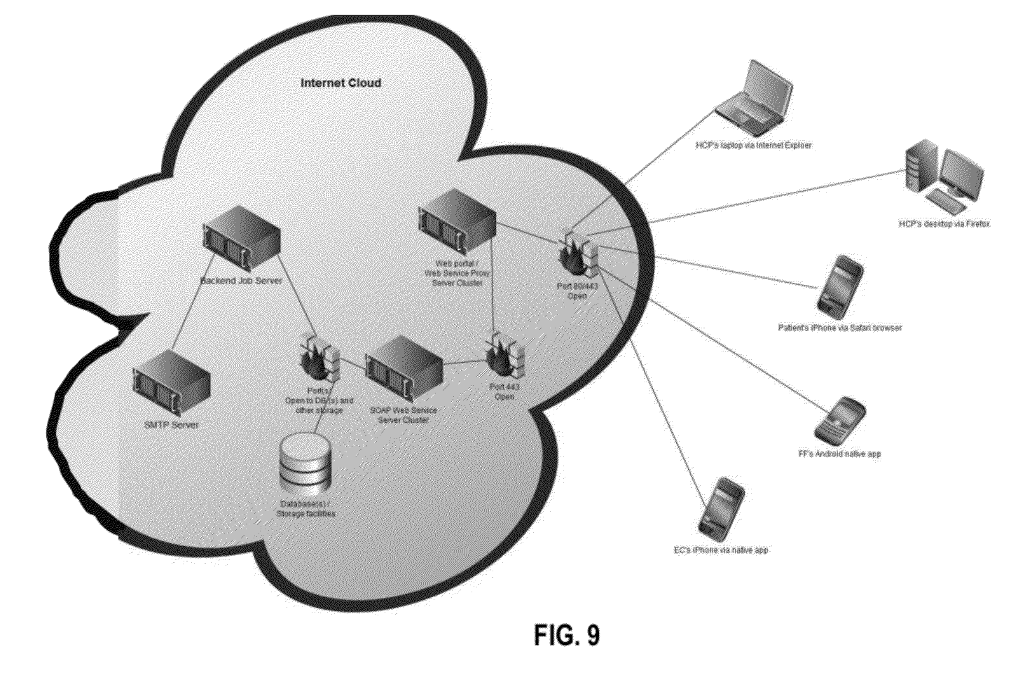

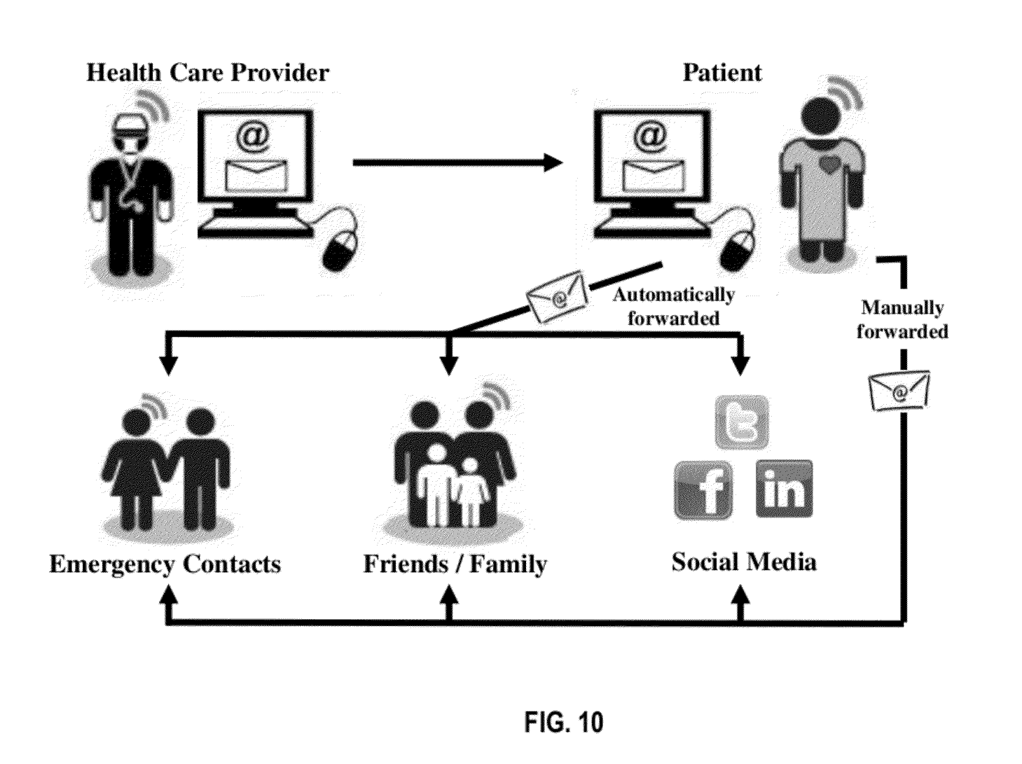

FIG. 9 depicts in schematic form the cloud-based computing aspects of the system and method of the invention. Within the Internet cloud, there is initially desirably provided a port serving as a firewall and screening all messages and other input provided to the cloud from various devices that are part of the MDconnectME system. The firewall allows access by legitimate, non-virus bearing messages to the web portal, which is a web service proxy server cluster. There is another firewall between that server and a “Simple Object Access Protocol” (SOAP) server cluster. A third firewall separates the SOAP web service server cluster from a data storage device such as a disk pack and from a back end job server, which in turn is connected to a “Simple Mail Transfer Protocol” (SMTP) server.

Outside of the Internet cloud, FIG. 9 depicts exemplary Internet-enabled devices that can be used working with and communicating within the MDconnectME system. These include a hospital care provider's laptop operating Internet Explorer, a hospital care provider's desktop computer operating Firefox, a patient's iPhone operating the Safari browser, friends and family contacts' Android using a native application and an emergency contact having an iPhone operating via a native application, all as indicated schematically in FIG. 9. It is to be understood that these devices, as listed and depicted as being suitable for use with the MDconnectME system, are exemplary, not limiting, and that other Internet-enabled devices could also be used.

As respecting the MDconnectME messaging protocol, when the MDconnectME system is off, messages sent from health care providers will arrive in the patient's inbox, but are not autoforwarded.

Patients have the option to further define their active configuration. These patient options may add restrictions to the visibility of members within the patient's health care personal network to other members of the patient's health care personal network The patient may also add restrictions to how each member of the health care personal network can communicate with other members of the patient's health care personal network.

Health care providers can send custom messages to a patient. Health care providers can also send status updates to the patient. If MDconnectME is turned on, a status update can be sent to the patient and then will be auto forwarded to the patient's emergency contacts and the patient's friends and family. If MDconnectME is turned off, a health care provider does have the capability to send either a status update or a custom message to the patient and those messages will not be autoforwarded to anyone within the patient's health care personal network.

Based on the preference of the patient and/or legal guardian/holder of a power-of-attorney, all, some, or none of the care team may see updates and messages that have been sent by any health care providers within the health care provider's organization.

All messages arrive in the patient's inbox and allow the patient to forward messages to emergency contacts, to friends and family, and to social networks, should the patient decide to re-transmit a message or forward important custom messages with attachments, e.g. video, audio, or photographic files.

Patients can send and/or forward status updates to emergency contacts only, to emergency contacts and to friends and family, to emergency contacts, to friends and family, and to the selected social networks, and to all possible combinations of these recipients.

For customized messages, MDconnectME employs an particular algorithm for the safety and delivery of messages contingent on individual consent prior to forwarding.

Emergency contacts are able to communicate with other emergency contacts and/or network participants, irrespective of MDconnectME's on/off status, and are determined by the patient's active preference.

Friends and family can send messages to following possible combinations: to the patient; to the patient and the patient's emergency contacts; or to the patient's friends and family, irrespective of the MDconnectME on/off status and based on the patient's active preference.

The following examples set forth various functions which may be performed in the course of practice of the method of the invention and performed by the MDconnectME system embodying the invention:

### Example 1

### A Health Care Organization Signs Up

Health care organization fills out appropriate forms and submits them to MDconnectME.
MDconnectME administrator is instructed to create healthcare organization system administrator(s).
MDconnectME administrator creates healthcare organization system administrator account(s).
The healthcare organization system administrator(s) is now able to create care team(s) and allow healthcare professionals to be entered into MDconnectME system and assigned to a given care team(s).

### Example 2

### A Healthcare Organization System Administrator Bulk Imports Healthcare Professionals/Care Team(s)

Healthcare organization system administrator creates a CSV (comma separated variable) file for each employee containing the following:
1) First name
2) Middle name
3) Last name
4) Title
5) Healthcare organization e-mail address
Healthcare organization system administrator navigates to staff administration within MDconnectME system.
Healthcare organization system administrator selects bulk import staff
Healthcare organization system administrator clicks button to browse for file, chooses comma separated variable (CSV) and clicks upload button
System verifies integrity of comma separated variable
System records user info and creates/sends email invite per healthcare professional with a link containing system guide back to MDConnectME system.
Once healthcare professional accepts invite, healthcare professional account is created and/or associated to care team(s).

### Example 3

### Healthcare Professional Accepts Invite from Healthcare Organization System Administrator and Creates an Account

Healthcare professional receives email with link url containing system guide.
Healthcare professional clicks link to MDconnectME.com.
Healthcare professional enters in the following information
1) First name (pre-populated/editable)
2) Middle name (pre-populated/editable)
3) Last Name (pre-populated/editable)
4) Primary phone
5) Pager number
6) Email address (pre-populated/editable)
7) DOB
8) Specialty
9) Title (pre-populated/editable)
10) CAPTCHA
11) Username
12) Password
13) Password2 (validation)
14) Healthcare professional is prompted to read through and sign terms and conditions.
15) Healthcare professional is now associated to department and can now communicate with patients associated with department

### Example 4

### Healthcare Professional Joins Hospital

Healthcare professional joins hospital
Healthcare professional is asked to create MDconnectME account and provide concierge with:
   Username
Healthcare professional creates account and/or supplies concierge with above criteria
Concierge searches for account by user name and validates user
Concierge accepts healthcare professional into hospital and accepts MDconnectME account as an affiliation with facility.

### Example 5

### Patient Enters Hospital

Patient enters hospital
Patient is asked to create an account and/or provide concierge with:
Username
Patient supplies concierge with above criteria
Concierge searches for account by user name and validates user information
Concierge accepts/admits user into hospital, accepts MDconnectME account, and associates user with their health care professionals.

### Example 6

### Account Creation

User visits MDconnectME and navigates to sign up
User is asked to enter:
   First name
   Middle name
   Last name
   Date of birth
   Login name
   Password
   Password 2(validation)
   Primary email
   CAPTCHA
User is prompted to read through and sign terms and conditions
User submits form
System sends email to user's primary email containing link (URL) back to MDconnectME with system guide
User opens email and clicks on link to finalize account creation
User logs in to MDconnectME and is now authorized

### Example 7

### User MDconnectME Contact Network Provisioning

User logs in
User opens MDconnectME Network section
User adds 1 or more emergency contacts(s)
   First name
   Middle name
   Last name
   Email address
User adds one or more friend/family(s)—same as above
   First name
   Last name
   Email Address
User submits MDconnectME contact network
System records and sends email(s) to each contact within user network
   Email contains 2 links back to MDconnectME containing system guide.
   Each contact has ability to accept/reject request
Once contact user accepts alerts/updates or creates an account then the user/doctor can send alerts/updates directly through MDconnectME to them, assuming auto-forward is activated.
If account is created then the doctor/user can send custom messages.

### Example 8

### Contact Acceptance—Sign-Up/Accept

Contact user (emergency contact/friend/family) receives email containing
   Requester's first/last name
   2 links (accept/reject) to MDconnectME containing system guide
Contact user clicks accept link to MDconnectME
Contact user is given options to:
   Sign-up and accept reverse order
   Log in
   Accept email alerts/updates
   Contact user chooses sign-up.
   Contact user is asked to enter in:
   First name (pre-populated/editable)
   Middle name
   Last name (pre-populated/editable)
   Date of birth
   Login name
   Password
   Password 2(validation)
   Primary email (pre-populated/editable)
   If edited another round of email/link and CAPTCHA is needed to prevent hijacking
   CAPTCHA
Contact user successfully enters CAPTCHA and all necessary fields.
Contact user is prompted to read through and sign terms and conditions
Contact user submits form
Contact user is now authenticated/authorized to receive Alerts/Updates directly through email and confidential information through MDconnectME
Thank you page is displayed for signing up for MDconnectME

### Example 9

### Contact Acceptance—Alert/Updates Only

Contact user (emergency contact/friend/family) receives email containing
   Requester's first/last name
   2 links (accept/reject) to MDconnectME containing system guide
Contact user clicks accept link to MDconnectME
Contact user is given option to:
   Sign-up and accept reverse order
   Log in
   Accept email alerts/updates
Contact user chooses accept alerts
Contact user is prompted with CAPTCHA
Contact user successfully enters CAPTCHA
Contact user is prompted to read through and sign terms and conditions
Contact user is now authorized to receive alerts/updates directly through email.
Thank you page is displayed for signing up for alerts

### Example 10

### Contact Acceptance—Log In and Accept Reverse Order

Contact user (emergency contact/friend/family) receives email containing
   Requester's first/last name
   2 links (accept/reject) to MDconnectME containing system guide
Contact user clicks accept link to MDconnectME
Contact user is given option to:
   Sign-up and accept reverse order
   Log in
   Accept email alerts/updates
Contact user chooses log in and accept
Contact user is prompted to log in with existing credentials
Contact user successfully logs in and accepts contact
Contact user is now authenticated/authorized to receive Alerts/Updates directly through email and confidential information through MDconnectME
Thank you page is displayed for accepting

### Example 11

### Contact Rejection

Contact user (emergency contact/friend/family) receives email containing
   Requester's first/last name
   2 links (accept/reject) to MDconnectME containing system guide.
Contact user clicks link to reject acceptance
Contact user is prompted with a dropdown to choose why they are rejecting
   Dropdown values
      Unknown contact
      Do not want alerts
      TBD
Contact user is prompted with a CAPTCHA
Contact user successfully enters CAPTCHA.
Thank you page is displayed for filling out info

### Example 12

### Organization Creates Message

Organization creates message “Mr. ______ (patient's last name) surgery has completed.” and targets the patient, the patient's emergency contacts and the patients friends and family.
The patient's preferences state that a health care provider can only send to the patient and the patient's emergency contacts.
When the message is sent from the health care provider, although the organization intended the message to go to the patient, the patient's emergency contacts and the patient's friends and family, the message is only delivered to the patient and the patient's emergency contact group, as dictated by the patient.

### Example 13

### Organization Creates Another Message

Organization creates message “Please call me at ______ (Doctor's name and cell phone number) and targets the patient and the patient's emergency contacts.
Patient's preferences state a health care provider can send messages to the patient, the patient's emergency contacts and the patient's friends and family.
When the message is sent from the health care provider, the message will only be delivered to the patient and patient's emergency contact group as defined by the organization

In a pilot trial of the system and method of the invention, a thirty-five year old paraplegic male patient, who had been shot in 2002, needed reconstructive surgery. The patient's mother, his source of support, was forced to remain at her work position, was not permitted leave, and hence could not be present in the waiting room during her son's surgery. Through use of the invention, the patient's mother was able to remain at her work station and yet be connected with the patient throughout the surgical procedure.

The patient exhibited a calmness once the patient was able to log on to the system embodying the invention and identified and installed his mother as his emergency contact. The patient forgot all of the unknowns associated with the surgery confronting him and instead was at ease with the simple knowledge that his mother would be with him, in a virtual sense, thanks to the cloud forwarding technology of this invention.

Working at her job fifty miles away to support her family, the patient's mother knew the exact second when her son was wheeled into the operating room for the procedure, as the attending physician dispatched one of the pre-selected messages to the patient's computer, which was programmed to forward those messages immediately to the patient's mother. The patient's mother knew the exact moment when her son went to sleep under anesthesia in a peaceful manner, as the attending physician transmitted another message to the patient's computer, which in turn automatically forwarded it directly to the patient's mother. The patient's mother knew within seconds that the surgery had commenced, as the attending physician pushed another button sending another pre-programmed message, previously approved by the patient, to the patient's mother through the patient's own computer. The patient's mother knew half-way through the operation that everything was going smoothly and “as planned” thanks to an instantaneous update the attending physician directed be sent by his attending nurse to the patient's mother through the patient's own computer. The patient's mother knew the precise minute that the surgery ended when the attending physician sent another message to the patient's computer which in turn forwarded that message to the patient's mother.

At the end of the procedure the patient's mother knew within a few minutes that her paralyzed son had reached the recovery room in a safe and sound condition, when the attending physician dispatched another, patient approved message, to the patient's computer which in turn (at the patient's pre-programmed direction), relayed that message to the patient's mother. When the patient awakened, the attending physician asked the patient what it felt like to be the first patient in the world to remain connected and in communication with his mother during surgery. The patient looked at the attending physician with a huge smile, patted the attending physician on his chest and said “It is amazing and I am forever thankful!”.

Shortly thereafter, the attending physician called the patient's mother to be sure that the patient's mother was in good condition. The attending physician detected no frightfulness and no anxiety in the mother's voice and there was no rush of questions asked by the mother of the attending physician. Instead, the attending physician found the patient's mother to be completely calm and collected. Indeed, the mother said to the attending physician “Thank you, very much for everything . . . I received every single update straight to my office computer . . . it felt as if I was there the whole time”.

It is to be understood that a user viewing any of the screens provided by MDconnectME also has conventional and well-established e-mail tools available on that screen, at the top of the screen, or at the bottom of the screen, or at the left-hand side of the screen, whereby messages may be deleted or forwarded, or the user viewing the screen may elect to reply to the message, all based on the user's preferences.

For example, when the user has logged into the Inbox and has selected to view messages from the top left navigation area, at this point, the user can view the most recent twenty-five messages sent to various personnel. Pagination allows for jumping from page to page; sorting is also enabled for these messages in a column by Sender, To, Subject, Date, By Attachment, and the like. There is provided a left-hand navigation memo allowing the user to save, send, place in the Outbox, put in the Trash Bin, or edit in the Inbox or provide in the Drafts folder, or to compose messages, in the same manner as conventional e-mail management programs provide.

As respecting the user's Sent box, the user may look at the Sent box displaying the most recent twenty-five messages the user has sent to be delivered to other users or groups, including to the user's healthcare provider. Pagination and sorting are provided that allow the user to search the Sent box and be able to reply, delete and forward messages on to the various patient's preferences, including the patient's physician. This message forwarding and management aspect of the MDconnectME system is one of the many benefits that a patient or user receives upon signing into the system and creating an account.

A Trash Box is provided to the user on the user's screen displaying the top twenty-five messages the user has most recently deleted. Pagination and sorting are both enabled in the Trash Box. The user is able to reply, delete permanently, or forward messages based on the patient's preferences. The messages arrive in the Trash Box when a user deletes a message from the Send outbox, Inbox or Draft folders.

Respecting the draft capability provided by MDconnectME, a user opening the Draft box receives a list of drafts of prior messages that have been prepared but have not been sent. The Draft box includes pagination, sorting and delete functionalities. Drafts are automatically saved so a user can respond, finish and send the message via the MDconnectME system.

Respecting the Outbox presented to a user upon signing on to MDconnectME, the user arrives at the Outbox displaying messages that are approved to be sent to other users or groups. The user has the option to delete a message if the message has not been sent by the time the user checks the Delete function. The Outbox functions to show the status of messages and whether they have been delivered. The Outbox also has pagination and sorting functionality.

The Inbox provided for the user in the MDconnectME system has messages displayed from the top left. At this point, the user can view the most recent twenty-five messages sent to their Inbox. Pagination allows the swapping from page to page and sorting is available by column, number, From, To, Subject, Date, Attachment and the like. A left-hand navigation functionality permits the user to see the Send, Outbox, Trash Box, Inbox and Drafts, and to compose messages therefor. All of this messaging capability is in addition to the user-controlled functionality with respect to the messages sent by the physician or the healthcare provider as set forth above.

In the MDconnectME system, all user names in the system are unique. If a new user chooses a user name that is already in the system, that new user will have to try to reestablish the user's account with a different user name.

It is within the scope of the invention to utilize an SMS gateway to send SMS messages to cell phones as part of the option package provided to users of the MDconnectME system.

The system of the invention may utilize “Transport Layer Security” (TLS) protocol or “Secure Socket Layer” (SSL) protocol to provide communication security in the messages sent over the Internet by the user, the healthcare provider and the like.

When SSL is used, web browsers connect using the secure socket layer encryption to the web portal to log-in and interact with MDconnectME. Native applications connect to the same cluster of servers over the secure socket layer, but have a proxied communication to the web service tier. The web service tier desirably contains common business logic for both the web portal and the native mobile applications. The web service tier also serves as an application layer and a three-tier architecture with increased security because it does not accept public traffic. The web service tier exposes a set of Simple Object Access Protocol (SOAP) based web service interfaces such as “Send Message”, “List Messages”, “List Patients”, “Add Contacts”, etc. The web service tier also performs database and other persistence operations.

When a healthcare provider sends a message through the secure web portal interface, the message flows from the browser to one of the web portal service cluster intakes. The web server validates the request and creates a SOAP request to one of the web service cluster intakes. The web service connects to the database and inserts the message into a database table. At this point, the web service responds back to the web portal with a successful response. The web server then responds back to the browser with a message stating that the message has been persisted and queued to be sent. In the background, the back end job server is running and determines that this is a message that needs to be sent, collects all of the contents of the message, and sends the message to the SMTP server. Recipients then receive an e-mail containing the healthcare provider message.

While the invention has been described as set forth above and has been implemented for the pilot trial as described above for use by hospital patients, their providers and other members of the patient's network, the invention is not so-limited. The invention may equally well be used by veterinarians, hospice workers, hospital chaplains, and other health care professionals such as dentists, oral surgeons, and the like. Additionally the invention finds utility in drug and psychiatric inpatient-rehabilitation centers, where emergency contacts and loved ones are often in search of updates.

The following is claimed:

1) A system for communicating status of individual patients to selected populations of recipients, comprising:
a) a computing platform;
b) a database in communication with the computing platform, comprising:
(i) a list of physicians authorized to use the computing platform to communicate patient conditions to selected populations of recipients;
(ii) a list of patients of the physicians;
(iii) a set of hierarchical lists of recipients for each of the listed patients, the hierarchy of lists being defined as to recipient importance, each list including contact information for each of the recipients on the list;
(iv) a set of patient condition messages for each of the patients
c) a first electronic communication device for use by a patient in communicating with said computing platform;
d) a second electronic communication device for use by a physician in communicating with said computing platform;
e) a third electronic communication device for use by a recipient, as approved by the patient, in communicating with said computing platform;
f) a software algorithm resident on said computing platform and controlled by said patient using said first communication device; for a given one of the physicians using said second electronic communication device to select one or more of the hierarchical recipient lists for a selected one of that physician's patients and to select a patient status message indicative of the patient's status from the set of messages for the selected patient; for retransmission to the third electronic communication device used by a recipient on the selected hierarchical list of the selected message upon enablement of said retransmission function of said algorithm by said first patient using said first communication device.

2) The system of claim 1 wherein the database further comprises a set of patient reminder messages accessible by each physician and the algorithm is further for a given one of the physicians to select a message from the set of patient reminder messages and to transmit the selected patient reminder message to the computing platform for retransmission to the patient.

3) The system of claim 2 wherein the patient reminder messages are preprogrammed.

4) The computer-based system of claim 1 where in the database further comprises:
a) a set of commercial advertising messages for transmission to the recipients set forth in the hierarchical lists; and wherein the algorithm is yet further for selecting one or more of the commercial advertising messages for transmission to the recipients set forth in the hierarchical lists as a part of a message selected by a physician for retransmission thereby to the recipients of the selected hierarchical lists(s).

5) A method for communicating the status of a patient undergoing hospital treatment to selected populations of recipients, comprising:
a) prior to the patient undergoing hospital treatment, compiling a collection of messages expected to reflect an individual patient's status at various times for various patient outcomes;
b) having the collection of messages approved by the patient prior to the patient undergoing the hospital treatment;
c) storing the collection of messages for the individual patient as approved thereby in electronic form in a database;
d) receiving from the individual patient one or more lists of recipients for selected ones of the messages reflecting the patient's condition at selected future times;
e) assigning pre-designated hierarchical positions to each recipient in the patient list based on the recipient's emotional and economic importance to the patient;
f) periodically selecting a message, from the collection of messages, reflective of the patient's current status;
g) selecting one or more hierarch ally ordered lists of recipients for distribution of the selected message thereto; and
h) transmitting the selected message to a computing platform controlled by the patient for optional retransmission to the recipients in the selected hierarchical groups.

6) A method for communicating the medical status of patients to selected populations of recipients, comprising:
a) prior to each patient undergoing hospital treatment, compiling a collection of messages expected to reflect that patient's status at various times for various patient outcomes;
b) presenting each collection of messages to the individual patient for whom the messages were collected, for approval or modification thereby by the patient prior to the patient undergoing hospital treatment;
c) storing the collections of messages for the individual patients as approved or modified by the individual patients in electronic form in a database;
d) receiving from each patient one or more lists of recipients for selected ones of the messages reflecting the patient's condition at selected future times;
e) assigning pre-designated hierarchical positions to each recipient in the patient list based on the recipient's emotional and economic importance to the particular patient;
f) for each patient undergoing hospital treatment, periodically selecting a message, from the collection of messages for that patient, reflective of the patient's current status;
g) selecting one or more of that patient's hierarch ally ordered lists of recipients for distribution of the selected message thereto; and
h) transmitting the selected message to a computing platform controlled by a particular patient for optional retransmission by the patient-controlled computer to the recipients in the selected hierarchical groups.

7) The system of claim 1 wherein the first, second and third electronic communication devices are selected, independently of one another, from the group comprising cellular telephones, smart phones, desktop computers; laptop computers, personal digital assistants, Internet-based telephones, and landline telephones.

8) The system of claim 1 wherein the computing platform comprises a SMTP server, a SOAP server, a proxy server, at least one backup server, at least one data storage medium, and firewall software.

9) A method for communicating the medical status updates of patients to selected populations of recipients, comprising:
a) prior to each patient undergoing hospital treatment, compiling and grouping a collection of individuals expected to be notified of the patient's status at various times and for various patient outcomes;
b) Storing the collections of categorized messages for use within the organization as approved or modified by the healthcare organization in electronic form in a database;
c) receiving from each patient one or more lists of recipients for receiving status update messages reflecting the patient's condition at selected future times;
d) assigning pre-designated hierarchical positions to each recipient in the patient list based on the recipient's emotional and economic importance to the particular patient;
e) for each patient undergoing hospital treatment, periodically selecting a message, from the collection of messages for that patient, reflective of the patient's current status;
f) selecting one or more of a patient's hierarchical ordered lists of recipient categories for a targeted distribution of the selected message thereto; and
g) transmitting the selected message to a computing platform controlled by a particular patient for optional retransmission by the patient-controlled computer to the recipients in the selected hierarchical groups.

10) The system of claim 1 wherein
a) the computing platform comprises a SMTP server, a SOAP server, a proxy server, at least one backup server, at least one data storage medium, and firewall software;
the database further comprises:
b) a set of patient reminder messages accessible by each physician and the algorithm is further for a given one of the physicians to select a message from the set of patient reminder messages and to transmit the selected patient reminder message to the computing platform for retransmission to the patient; and
c) a set of commercial advertising messages for transmission to the recipients set forth in the hierarchical lists;
d) and the algorithm selects one or more of the commercial advertising messages for transmission to the recipients set forth in the hierarchical lists as a part of a message selected by a physician for retransmission thereby to the recipients of the selected hierarchical lists(s);
e) and the computing platform comprises a SMTP server, a SOAP server, a proxy server, at least one backup server, at least one data storage medium, and firewall software.

11) A method for communicating the status of a patient undergoing hospital treatment to selected populations of recipients, comprising:
a) prior to the patient undergoing hospital treatment, compiling a collection of messages expected to reflect an individual patient's status at various times for various patient outcomes;
b) storing the collection of messages for the individual patient as approved thereby in electronic form in a database comprising:
(i) a list of physicians authorized to use the computing platform to communicate patient conditions to selected populations of recipients;
(ii) a list of patients of the physicians; and
(iii) a set of hierarchical lists of recipients for each of the listed patients, the hierarchy of lists being defined as to recipient importance, each list including contact information for each of the recipients on the list;
c) receiving from the individual patient one or more lists of recipients for selected ones of the messages reflecting the patient's condition at selected future times;
d) assigning pre-designated hierarchical positions to each recipient in the patient list based on the recipient's emotional and economic importance to the patient;
e) periodically selecting a message, from the collection of messages, reflective of the patient's current status;
f) selecting one or more hierarch ally ordered lists of recipients for distribution of the selected message thereto; and
g) transmitting the selected message in encrypted form over the Internet to a computing platform comprising at least one server, firewall software and a mass data storage device, for retransmission, at the option of the patient, in encrypted form over the Internet to the recipients in the selected hierarchical groups.

12) The method of claim 5 wherein the messages are transmitted over the Internet.

13) The method of claim 13 wherein the messages are encrypted.

14) The method of claim 6 wherein the messages are transmitted over the Internet.

15) The method of claim 14 wherein the messages are encrypted.

16) The method of claim 9 wherein the messages are transmitted over the Internet.

17) The method of claim 17 wherein the messages are encrypted.

18) The system of claim 1 wherein the transmitted messages and the retransmitted messages are encrypted.

19) The system of claim 1 wherein the transmitted messages and the retransmitted messages are sent over the Internet.

20) The method of claim 9 wherein one of the hierarchical groups includes social media including but not limited to Facebook, Twitter and Linked-In.
